(19) United States
(12) Patent Application Publication
(10) Pub. No.: US 2001/0032123 A1
(43) Pub. Date: Oct. 18, 2001

(54) Electronic commerce utilizing a value parameter

(76) Inventors: Megan Burns, Erie, PA (US); Jeffery M. Smith, Erie, PA (US); Ming Ai Tang, Erie, PA (US); Christopher John Vereb, North East, PA (US); Lisa Michelle Zaczyk, Erie, PA (US); Bruce M. Sweeley, Erie, PA (US); Dennis C. Taylor, Fairview, PA (US); Juliana Rocco Salles de Faria, Erie, PA (US); Anthony F. Maciulewicz, Grapevine, TX (US); Su Ann Koniecki, Erie, PA (US)

Correspondence Address: David G. Maire, Esquire, Holland & Knight, LLP, P.O. Box 1526, Orlando, FL, 32802-1526, US

(21) Appl. No.: 09/734,503

(22) Filed: Dec. 11, 2000

Related U.S. Application Data
(60) Provisional application No. 60/190,680, filed on Mar. 20, 2000.

(51) Int. Cl. G06F 17/60

(52) U.S. Cl. 705/14; 705/36; 705/27; 705/7

(57) ABSTRACT

A method and apparatus for conducting electronic commerce wherein a prospective purchaser is given data indicative of a calculated value of a product to the prospective purchaser arising from the prospective purchase and use of the product. A prospective purchaser provides application specific information to a supplier via an Internet web page to identify the anticipated conditions of use of a product under consideration. The supplier calculates a value parameter responsive to the application specific information and communicates it back to the prospective purchaser. The value parameter may include, for example, return on investment, pay-back period, fuel savings, reduction in operating cost, etc. The value parameters for several alternative products may be compared and a recommended product identified. The application specific information provided by the prospective purchaser may be analyzed to identify further sales opportunities.

This application claims benefit of the Mar. 20, 2000, filing date of U.S. provisional patent application No. 60/190,680.

### BACKGROUND OF THE INVENTION

The present invention relates generally to the field of electronic commerce.

The number of electronic commerce (e-commerce) sites on the Internet is growing rapidly, and the volume of commerce being conducted over the Internet is expanding accordingly. A shopper at an e-commerce site can access multi-media information describing a large number of items. Some prospective buyers utilize the Internet simply to gather information, thereby reducing the amount of time spent in physically shopping at retail stores. Some shoppers proceed to make purchases by using a telephone, preferring to interact directly with a human being. Increasingly, purchases are conducted electronically. The shopper may select one or several items for purchase by communicating with the supplier via a web page graphical user interface (GUI), such as by placing the items in a virtual shopping cart. Once all desired items are selected, the shopper may authorize a purchase by providing a credit card number or account number. Delivery is arranged and the transaction is completed without buyer and seller ever interfacing directly. One computer system and method for conducting commerce in this manner is described in U.S. Pat. No. 5,710,887 issued on Jan 20, 1998.

While e-commerce can be very cost effective, is has many limitations. Many shoppers are concerned about the security of transmitting financial information over the Internet. Many encoding and security techniques have been devised to address this concern. Other shoppers want to physically inspect a product before making a final decision. Liberal return/exchange policies are offered to overcome this impediment. These approaches are generally effective for selling consumer products via the Internet. But the most significant shortcoming of electronic commerce from the seller's perspective is the lack of the influence of a professional salesperson. This shortcoming is particularly problematic for selling industrial and commercial products. There is an old saying about the salesman who was so effective that he could sell refrigerators to Eskimos. While somewhat nonsensical, that old saying reflects a general consensus that a professional salesperson can have a powerful buying influence on a perspective purchaser.

Electronic commerce has been, to date, a sterile experience. Although presented with a dazzling display of the latest multi-media effects, the prospective purchaser finds that shopping on the Internet is not much more informative than just looking at a product catalog. What is needed is a way to bring to e-commerce at least a portion of the personal touch that a professional salesman provides.

### BRIEF SUMMARY OF THE INVENTION

Accordingly, the present invention recognizes that the key buying influence for many prospective purchasers, especially commercial purchasers, is the value that a particular product will generate after it is purchased. The method and apparatus of the present invention utilizes the tools of electronic commerce to present a value story to the prospective purchaser. Because the value generated by a product will depend upon how that product will be used by that particular purchaser, the present invention provides an interactive web page for obtaining application specific information from the prospective purchaser. A value parameter that is responsive to the application specific information is then generated and communicated electronically to the prospective purchaser. The value parameter may take any appropriate form, such as a return on investment, payback period, cost savings projection, etc.

A method of electronic commerce is described herein as including: providing access to information related to a product to a prospective purchaser of the product via an information network; receiving application specific information related to prospective use of the product from the prospective purchaser via the information network; producing data responsive to the application specific information and related to value to the prospective purchaser arising from purchase and use of the product; and communicating the data to the perspective purchaser. The method may further include: calculating a return on investment parameter responsive to the application specific information; and providing the return on investment parameter to the prospective purchaser. The calculated value data may be used to identify a recommended product for the prospective purchaser's specific application. The application specific information collected during the electronic commerce transaction may be used to identify a further sales opportunity.

A further method of electronic commerce is described herein for the railroad industry as including: providing access to information related to a locomotive upgrade product to a prospective purchaser via an information network; receiving railway specific information related to prospective use of the locomotive upgrade product from the prospective purchaser via the information network; producing a return on investment parameter responsive to the railway specific information and related to purchase and use of the locomotive upgrade product; and communicating the return on investment parameter to the prospective purchaser via the information network. The method may further include: providing access to information related to at least two locomotive upgrade products to the prospective purchaser via the information network; producing a return on investment parameter responsive to the railway specific information related to purchase and use of each of the at least two locomotive upgrade products; using the return on investment parameters to identify a recommended locomotive upgrade product; and communicating the recommended locomotive upgrade product to the prospective purchaser via the information network. Railway specific terrain profile information received from the prospective purchaser may be used to produce a fuel savings parameter responsive to the railway specific terrain profile information.

The method may be facilitated by presenting a plurality of pull-down menus to the prospective purchaser via an Internet web site to facilitate communication of the application specific information, and further providing default data for each of the pull-down menus for those instances where the prospective purchaser does not provide application specific data.

An apparatus for conducting electronic commerce is described herein as including: a supplier data processor having access to data related to a plurality of products and having access to an information network; a prospective purchaser data processor having access to the information network for displaying the data related to the products and for providing to the supplier data processor application specific data related to prospective use of at least one of the products by the prospective purchaser; program instructions executable by the data processor to generate value data responsive to the application specific data and representing value to the prospective purchaser arising from purchase and use of the at least one of the products.

### BRIEF DESCRIPTION OF THE DRAWINGS

FIG. 1 is a schematic illustration of an electronic commerce system linking a supplier with a plurality of prospective purchasers via a global information network.

FIG. 2 illustrates a method of electronic commerce.

FIGS. 3-7 are a screen images of Internet web pages used in one embodiment of the method of FIG. 2.

### DETAILED DESCRIPTION OF THE INVENTION

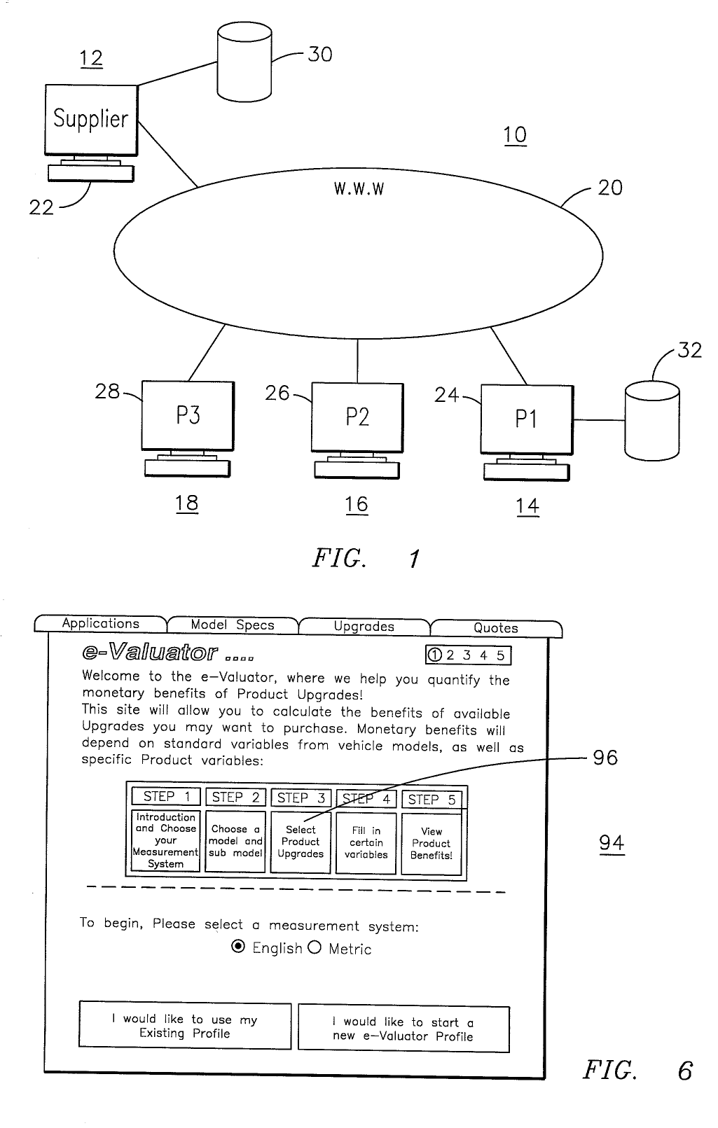

An apparatus 10 for conducting electronic commerce is illustrated in FIG. 1. A supplier 12 is able to communicate electronically with a plurality of prospective purchasers 14,16,18 via a global information network 20. The World Wide Web of the Internet is the information network of choice in today's marketplace, however, one may appreciate that the present invention may be implemented with any type of information network 20, such as hardwired or wireless, public or private, telephone, satellite, laser, microwave, infrared, etc. The supplier 12 and purchasers 14,16,18 maintain respective data processors 22, 24, 26, 28 having access to the information network 20.

The supplier data processor has access to data related to a plurality of products. The term “product” is used broadly herein to include any commercial offering by a supplier, and specifically including equipment, software and services. The product data may be maintained in any machine-readable data storage medium 30 accessible by the data processor 22, such as a hard or floppy disc drive, remote access memory, optical disc drive, etc. The data storage medium 30 also includes machine-executable instructions to enable the data processor 22 to provide access to product information to the prospective purchasers 14,16,18 through the information network 20, such as by maintaining an Internet web site. One example of such a web site maintained by the assignee of the present invention for presenting information related to transportation products is www.rightonrails.com.

The prospective purchasers' data processors 24,26,28 are provided with machine-executable instructions to enable the product information to be displayed at the prospective purchasers' site in multi-media format. Such technology is known in the art and includes Microsoft Corporation's Internet Explorer. Data processors 24,26,28 are also provided with the capability to access purchaser specific data, as may be stored on machine-readable data storage medium 32. Data storage medium 32 further includes machine-executable instructions for using data processor 24 to communicate such data to the supplier 12 via the information network 20. The supplier's data processor 22 includes program instructions executable to receive the purchaser specific data and to generate value data responsive to the purchaser specific data. The value data, as will be described in more detail below, represents value to the prospective purchaser arising from the purchase and use of at least one of the products being offered by the supplier 12.

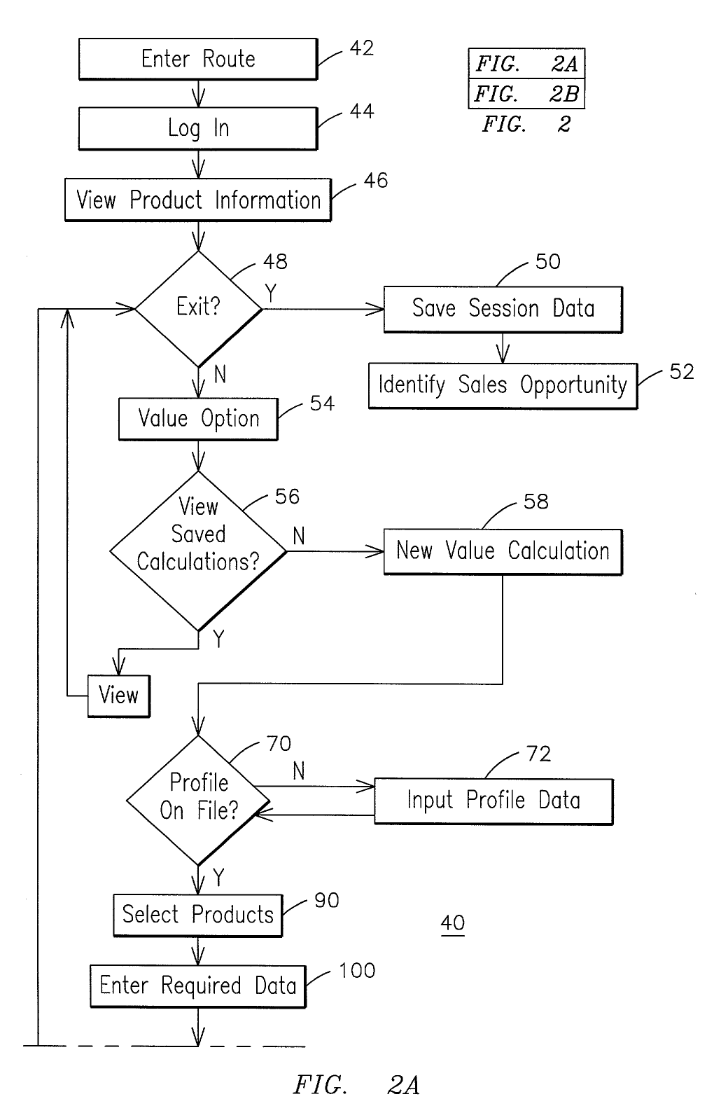

FIG. 2 illustrates a method 40 of conducting electronic commerce which may be implemented by the apparatus 10 of FIG. 1. A prospective purchaser 14 accesses an Internet web site at step 42 and is prompted to enter log in data at step 44. Identification of the system user via the log in step 44 is useful for later analysis of the data generated by the perspective purchaser 14. The prospective purchaser may then view product information at step 46. The product information may describe one or more products, including information such as the product specifications, price, availability, and general benefits provided by the product to a prospective purchaser. The prospective purchaser may elect to exit the site at step 48, whereupon selected data related to the session may be saved by the supplier 12 for future use. Such future uses may include identifying a further sales opportunity at step 52, including scheduling a later communication such as an e-mail to an address provided as part of the log in step 44 or a personal contact.

The prospective purchaser 14 may elect to enter a product value section of the web site at step 54. If this is not the first visit by the prospective purchaser to the site, the option of viewing previous session results is provided at step 56. The prospective purchaser may initiate a new value calculation session at step 58.

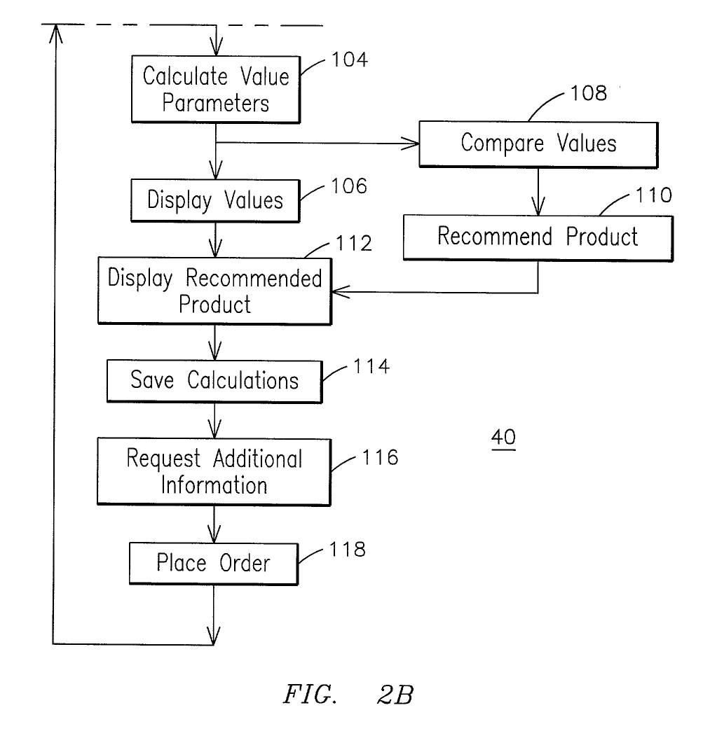

FIG. 3 is a screen image from an Internet web page 60 that implements certain of the steps of FIG. 2 for a railroad product application where a prospective purchaser is considering alternative new locomotives for purchase. Step 56 previous session results are made available by a single click of virtual button 62. The prospective purchaser may select an English or metric measurement system at virtual buttons 64. The prospective purchaser is then prompted to enter additional identification information, such as the name of a railroad company 66 or country of operation 68. Such selection may automatically set certain variables used for later calculations, for example the currency to be used for financial information. The user may have the opportunity to change such variables on later web pages. Once the prospective purchaser has provided information identifying an existing locomotive, a list of potential replacement locomotives may be provided via the web site. These potential replacement locomotives are selected for presentation only if they are capable of at least the same hauling capability as the existing locomotive. The prospective purchaser may be presented with side-by-side specifications for the existing locomotive and each of several potential replacement locomotives.

Step 70 of FIG. 2 allows the prospective purchaser to use an existing profile, or to create a new profile of application specific information. For example, by identifying a specific railroad on the web page 60 of FIG. 3, certain railroad specific information may be accessed. Because certain purchaser data is generally static, such as the location, length and grade of rail lines, such purchaser specific data may be stored in the supplier's data storage media 30. If such user-specific information is not available or needs to be changed, the prospective purchaser is prompted to provide such information to the supplier via the information network 20.

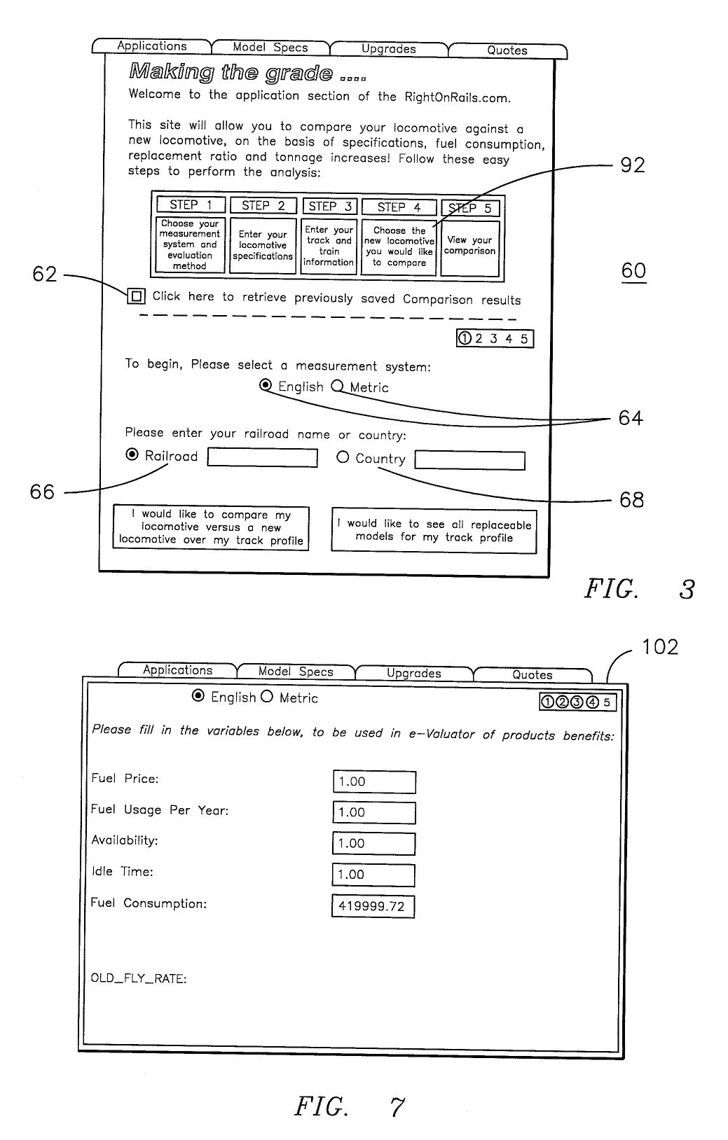

FIG. 4 illustrates an Internet web page 70 useful for providing such application specific profile data at step 72. Web page 70 is designed for use in a railroad application. Note that certain of the data fields are provided as pull-down menus, such as the gauge 74 of the rail. Pull-down menus facilitate the entry of data and reduce the chance of error for entering data where the number of choices is fairly limited. Furthermore, they provide a convenient manner in which to ensure that data is entered for all necessary fields. If the prospective purchaser does not enter data in such fields, a default value is used, such as the selection of a freight application at menu 76. Web page 70 is useful for providing railway information related to the terrain over which a prospective purchaser plans to operate a locomotive, such as the ruling grade in the rail system.

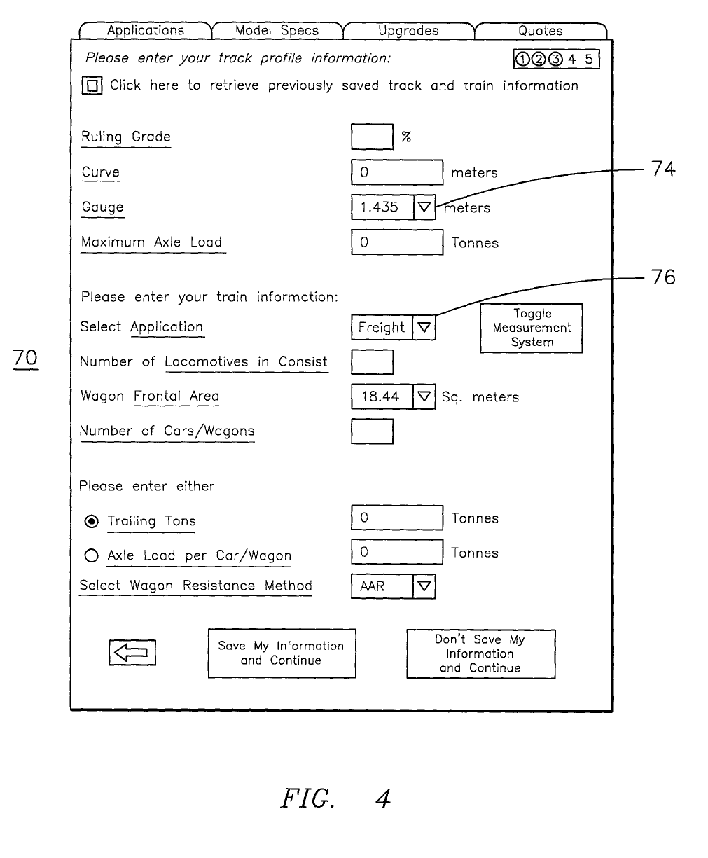

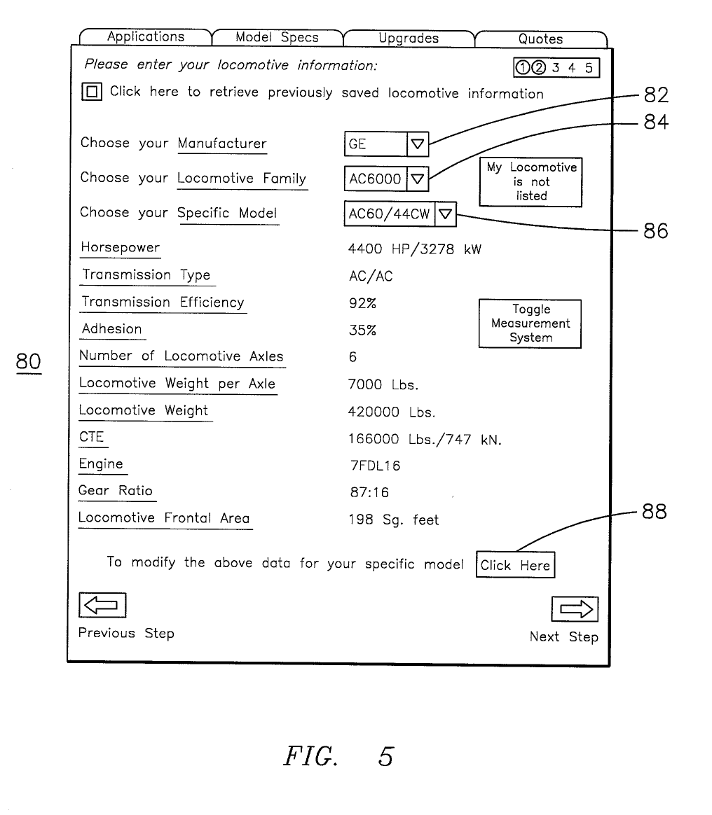

Step 90 of FIG. 2 provides the prospective purchaser the opportunity to select one or more products for evaluation. Hypertext link 92 of FIG. 3 is one example of this step for the application of the marketing of new locomotives. FIG. 6 illustrates a similar Internet web page 94 having a hyperlink for selecting among a plurality of product upgrades for an existing rail locomotive. FIG. 5 illustrates an Internet web page 80 useful for communicating application specific information regarding a locomotive of concern to a prospective purchaser of an upgrade product for the locomotive. Pull-down menus 82,84,86 are used to identify the locomotive based upon its general characteristics. The prospective purchaser is provided the opportunity to modify this data by operating virtual button 88. A prospective purchaser who manages a fleet of vehicles may provide application specific information regarding the fleet.

Step 100 of FIG. 2 illustrates the prospective purchaser providing application specific data that may be unique for a particular product. For the rail locomotive upgrade example, FIG. 7 illustrates an Internet web page 102 that may be used by the prospective purchaser 14 to communicate application specific information related to fuel usage to the seller 12 via the global information network 20. Here, again, a choice between English and metric units is provided to facilitate the data input.

Once the appropriate application specific information is available in the seller's data storage medium 30, an application specific value parameter may be determined at step 104. The term value parameter is used herein to mean any quantitative measure of value derived by the prospective purchaser as a result of a prospective product purchase. Common examples of value parameters include return on investment, payback period, fuel savings, reduction in maintenance cost, etc. For locomotive applications, the value parameter may include increased tonnage opportunity, i.e. the additional load that may be pulled by a replacement locomotive when compared to an existing locomotive, or a replacement ratio, i.e. the number of replacement locomotives divided by the number of existing locomotives necessary to transport the same load. The value parameter is calculated or otherwise produced by using at least some of the application specific information provided by the prospective purchaser. The value parameter is then communicated to the prospective purchaser at step 106, such as by displaying the value on a web page accessible via the information network 20, preferably in print-ready format for recording by the user. In one embodiment, a plurality of value parameters may be provided for a plurality of alternative products under consideration by the prospective purchaser or identified by the supplier in response to the selections made by the prospective purchaser. The plurality of value parameters may then be compared at step 108 to identify a recommended product at step 110 having the highest value to the prospective purchaser. A product recommended for purchase is then displayed at step 112, and the user is queried if the value calculations should be saved at step 114. For the operator of a fleet of vehicles, the value parameters may be displayed for the entire fleet or for any portion thereof, such as those vehicles in the fleet where the value would be the highest for a particular upgrade. The supplier may evaluate the fleet data and make a recommendation at step 112 that certain products be purchased for certain vehicles, based upon the fleet specific information provided by the purchaser. Before ending the session, the prospective purchaser is also queried at step 116 whether any additional information is desired, and at step 118 whether a purchase is desired.

The multi-media power of the Internet may be useful for implementing the method of FIG. 2. In one embodiment, value data is presented to the prospective purchaser using a color scheme wherein the color of the display of step 106 corresponds to a numeric magnitude of the value parameter. For example, a payback period longer than five years is calculated, that information is displayed in red. A payback period of three to five years may be displayed in yellow, and a payback period less than three years may be displayed in green.

The machine-executable instructions stored on the machine-readable data storage medium 30 for calculating a value parameter will vary for each application of this invention. For the purpose of illustration, instructions for calculating a fuel savings parameter resulting from the implementation of an upgrade to a locomotive will be discussed herein. The application specific information required for such a calculation may include the price of fuel; the current annual expenditure on fuel; the duty cycle, i.e. percentage of time that the locomotive is operated at various throttle settings; the current average fuel economy during operation; etc. Where such data is not provided by the prospective purchaser, default data must be used, such as an average fuel price for a particular area of the country. Other information may be dependent upon the particular product being considered, such as the improvement in fuel economy derived at full power from a particular upgrade product. An annual fuel cost savings number may then be derived by solving equations, using look-up tables, or other known calculation technique. For example, fuel savings may be found to be equal to [fuel cost]×[fuel efficiency improvement]×[existing fuel consumption rate]×[duty cycle]. The fuel savings may be calculated on the basis of a generic duty cycle, or it may be based upon a railroad specific duty cycle provided by the prospective purchaser via the Internet web site. Similarly, a return on investment parameter may be calculated by dividing the fuel savings value by the total cost of the upgrade.

For an application where the product is an off-highway vehicle or upgrades thereto, and the prospective purchaser is an operator of an off-highway mining vehicle, the application specific information may include mine specific data such as the total system operating cost without a certain upgrade. A value parameter calculated in step 104 may be the total system operation savings to the mine operator. This value parameter may be calculated by first using mine specific information to estimate the savings produced by a particular upgrade. That savings is then subtracted from the total system operation cost without the upgrade to arrive at a total system operation savings. One may appreciate that such simple calculations are not likely to be used in a real-world application, but they are provided to show examples of how the method of FIG. 2 may be implemented by the apparatus shown in FIG. 1.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

We claim as our invention:

1. A method of electronic commerce comprising:
providing access to information related to a product to a prospective purchaser of the product via an information network;
receiving application specific information related to prospective use of the product from the prospective purchaser via the information network;
producing data responsive to the application specific information from the prospective purchaser and indicative of a calculated value of the product to the prospective purchaser arising from a prospective purchase and use of the product; and
communicating the data to the prospective purchaser via the information network.

2. The method of claim 1, further comprising:
calculating a return on investment parameter responsive to the application specific information; and
communicating the return on investment parameter to the prospective purchaser.

3. The method of claim 2, further comprising providing the data to the prospective purchaser via a graphical user interface using a color scheme responsive to a level of the return on investment parameter.

4. The method of claim 1, further comprising:
saving at least a portion of the application specific information; and
using the saved portion of the application specific information in a further product sales opportunity.

5. The method of claim 1, further comprising querying the prospective purchaser via the information network regarding the prospective purchaser's interest in additional information regarding the product.

6. The method of claim 1, further comprising querying the prospective purchaser via the information network regarding the prospective purchaser's desire to make a purchase.

7. The method of claim 1, further comprising providing a graphical user interface for receiving application specific information from a prospective purchaser's data processor via the information network.

8. The method of claim 7, further comprising providing the data to the prospective purchaser via the graphical user interface in a print-ready format.

9. The method of claim 1, wherein the prospective purchaser is an operator of an off-highway mining vehicle, the product is an upgrade to the vehicle, and the application specific information comprises mine specific information including a total system operating cost without the upgrade, and further comprising:
calculating a total system operation cost with the upgrade;
subtracting the total system operating cost with the upgrade from the total system operating cost without the upgrade to obtain the total system operation savings; and
communicating the total system operation savings to the operator.

10. A method of electronic commerce comprising:
providing access to information related to a plurality of products to a prospective purchaser via an information network;
receiving application specific information related to prospective use of at least two of the products from the prospective purchaser via the information network;
producing data responsive to the application specific information from the prospective purchaser and indicative of calculated values of the products to a prospective purchaser arising from the prospective purchase and use of each of the at least two of the products; and
communicating the data to the prospective purchaser via the global information network.

11. The method of claim 10, further comprising:
using the data to identify a recommended product to be purchased by the prospective purchaser; and
communicating the recommendation to the prospective purchaser.

12. The method of claim 10, further comprising:
providing an Internet web site containing information related to a plurality of vehicles;
receiving application specific information related to the prospective purchaser's projected use of a vehicle;
producing a return on investment parameter responsive to the application specific information for at least one of the plurality of vehicles; and
communicating the return on investment parameter to the prospective purchaser via the information network.

13. The method of claim 12, further comprising receiving application specific information related to the terrain over which the prospective purchaser anticipates use of a vehicle.

14. A method of electronic commerce comprising:
providing access to information related to a product to a prospective purchaser of the product via an information network;
receiving application specific information related to prospective use of the product from the prospective purchaser via the information network;
producing data responsive to the application specific information from the prospective purchaser and indicative of a calculated value of the product to the prospective purchaser arising from a prospective purchase and use of the product;
communicating the data to the prospective purchaser; and
using the application specific information to identify a further sales opportunity.

15. A method of electronic commerce comprising:
providing access to information related to a locomotive upgrade product to a prospective purchaser via an information network;
receiving railway specific information related to prospective use of a locomotive utilizing the locomotive upgrade product from the prospective purchaser via the information network;
producing a return on investment parameter responsive to the railway specific information from the prospective purchaser and indicative of a calculated value of the product to the prospective purchaser arising from a prospective purchase and use of the locomotive upgrade product; and
communicating the return on investment parameter to the prospective purchaser via the information network.

16. The method of claim 15, further comprising:
providing access to information related to at least two locomotive upgrade products to the prospective purchaser via the information network;
producing return on investment parameters responsive to the railway specific information related to a prospective purchase and use of each of the at least two locomotive upgrade products; and
communicating the parameters to the prospective purchasers.

17. The method of claim 16, further comprising:
using the return on investment parameters to identify a recommended locomotive upgrade product; and
communicating the recommended locomotive upgrade product to the prospective purchaser via the information network.

18. A method of electronic commerce comprising:
providing access to information related to a locomotive upgrade product to a prospective purchaser via an information network;
receiving railway specific information related to prospective use of a locomotive utilizing the locomotive upgrade product from the prospective purchaser via the information network;
producing a fuel savings parameter for the locomotive upgrade product responsive to the railway specific information from the prospective purchaser; and
communicating the fuel savings parameter to the prospective purchaser via the information network.

19. The method of claim 18, further comprising:
receiving railway specific terrain profile information from the prospective purchaser; and
producing the fuel savings parameter responsive to the railway specific terrain profile information.

20. A method of electronic commerce comprising:
providing access to information related to a product to a prospective purchaser via an Internet web site;
requesting application specific information related to prospective use of the product from the prospective purchaser via the Internet web site;
providing default data for a portion of the application specific information for which the prospective purchaser need not provide application specific data;
producing value data responsive to the application specific information and indicative of a calculated value of the product to the prospective purchaser arising from purchase and use of the product; and
communicating the value data to the prospective purchaser via the Internet site.

21. The method of claim 20, further comprising:
presenting a plurality of pull-down menus to the prospective purchaser via the Internet web site to facilitate communication of the application specific information; and
providing default data for each of the pull-down menus.

22. The method of claim 20, further comprising presenting the value data via the Internet web site using a color scheme wherein the color of a display corresponds to a numeric magnitude of the value data.

23. A method of electronic commerce between a prospective purchaser who manages a fleet of vehicles and a supplier of equipment, the method comprising:
a supplier providing access to product information related to at least one product for prospective use in the fleet of vehicles via an information network;
a prospective purchaser providing fleet information specific to a fleet of vehicles to the supplier;
the supplier producing data responsive to the fleet information and indicative of a calculated value of the product to the prospective purchaser arising from a perspective purchase and use of the at least one product for at least one vehicle in the fleet; and
the supplier communicating the data to the prospective purchaser via the information network.

24. The method of claim 23, further comprising:
the supplier producing a plurality of data sets responsive to the fleet information and related to respective alternative values to the prospective purchaser arising from purchase and use of a respective alternative plurality of at least one product for at least one vehicle in the fleet; and
the supplier using the plurality of data sets to identify a recommended purchase; and
the supplier communicating the recommended purchase to the prospective purchaser via the information network.

25. An apparatus for conducting electronic commerce comprising:
a supplier data processor having access to data related to a plurality of products and having access to an information network;
a prospective purchaser data processor having access to the information network for displaying the data related to the products and for providing to the supplier data processor application specific data related to prospective use of at least one of the products by the prospective purchaser;
program instructions executable by the supplier data processor to generate value data responsive to the application specific data and representing a calculated value to the prospective purchaser arising from a prospective purchase and use of the at least one of the products.

26. A machine-readable data storage medium encoded with a set of machine-executable instructions for using a data processing system to perform a method for conducting electronic commerce, the method comprising:
providing access to information related to a product to a prospective purchaser of the product via an information network;
receiving application specific information related to prospective use of the product from the prospective purchaser via the information network;
producing data responsive to the application specific information and indicative of a calculated value of the product to the prospective purchaser arising from a prospective purchase and use of the product; and
communicating the data to the prospective purchaser.

27. A method of electronic commerce comprising:
providing an Internet web site for the exchange of information related to a plurality of locomotive products;
obtaining information related to an existing locomotive owned by a prospective purchaser via the Internet web site;
providing a list of potential replacement locomotives to the prospective purchaser via the Internet web site, the list of potential replacement locomotives being responsive to the existing locomotive information;
calculating a value parameter comparing each of the potential replacement locomotives to the existing locomotive, the value parameter comprising at least one of a fuel savings parameter, a replacement ratio, and an increased tonnage opportunity; and
communicating the value parameters to the prospective purchasers via the Internet web site.

28. The method of claim 27, further comprising:
receiving railroad specific duty cycle information from the prospective purchaser via the Internet web site; and
calculating a fuel savings parameter responsive to the railroad specific duty cycle information.
